(19) United States
(12) Patent Application Publication
(10) Pub. No.: US 2017/0153107 A1
(43) Pub. Date: Jun. 1, 2017

(54) OPTOELECTRONIC DEVICE INCLUDING EVENT-DRIVEN PHOTO-ARRAY AND METHOD FOR OPERATING THE SAME

(71) Applicant: Heptagon Micro Optics Pte. Ltd., Singapore (SG)

(72) Inventors: Stephan Beer, Schaffhausen (CH); Markus Rossi, Jona (CH); Bernhard Buettgen, Adliswil (CH)

(73) Assignee: Heptagon Micro Optics Pte. Ltd., Singapore (SG)

(21) Appl. No.: 15/363,120

(22) Filed: Nov. 29, 2016

Related U.S. Application Data
(60) Provisional application No. 62/260,788, filed on Nov. 30, 2015.

(51) Int. Cl. G01B 11/14; H05B 37/02

(52) U.S. Cl. CPC G01B 11/14; H05B 37/0227; H05B 37/0281

(57) ABSTRACT

This disclosure describes optoelectronic devices that include an event-driven photo-array and methods for using the same. The methods include capturing output signals over a particular illumination time via a change-detection circuit. In some instances, a threshold intensity change can trigger the change-detection circuit. In some instances, an active illumination from an illumination module may produce the threshold intensity change. Output signals may be used to generate distance data. In some instances, the output signals may be substantially free from noise due to background light.

### CROSS-REFERENCE TO RELATED APPLICATION(S)

This application claims the benefit of priority of U.S. Provisional Patent Application No. 62/260,788, filed on Nov. 30, 2015, the contents of which are incorporated herein by reference in their entirety.

### FIELD OF THE DISCLOSURE

The present disclosure relates to optoelectronic devices that include an event-driven photo-array and methods for using the same.

### BACKGROUND

Optoelectronic devices operable to generate output signals from light incident on photo-sensitive arrays sometimes are susceptible to spurious signals caused by ambient light, such as background light. Such optoelectronic devices can include devices operable to collect three-dimensional data such as stereo cameras and structured-light cameras. Such devices sometimes include illumination modules configured to assist or enable the collection of data by producing an active illumination. The active illumination, however, may be obscured by ambient light, such as sunlight. In some instances, the ambient light or background light can saturate photo-sensitive arrays. In some instances, the ambient light can obfuscate the active illumination such that the output signals generated from the photo-sensitive arrays are unreliable or noisy.

### SUMMARY

This disclosure describes optoelectronic devices that include an event-driven photo-array, and methods for using the same, which overcome some of the challenges posed by background light, ambient light, or other light. In one aspect for example, an optoelectronic device includes an event-driven photo-array that includes a change-detection circuit. The change-detection circuit can be triggered by a threshold intensity change. Further, the change-detection circuit can be operable to generate output signals. The optoelectronic device also includes a processor in communication with the event-driven photo-array, and an illumination module operable to direct an active illumination onto an object.

In some implementations, for example, the optoelectronic device includes an illumination module operable to adjust the power of an active illumination such that the active illumination directed onto an object and reflected to an event-driven photo-array exceeds a threshold intensity change.

In some implementations, the optoelectronic device includes a structured-light active illumination.

In some implementations, the optoelectronic device includes a processor operable to generate distance data from output signals and a structured-light illumination.

In some implementations, the optoelectronic device includes an optical channel. The optical channel can include, for example, an optical element assembly aligned to an event-driven photo-array.

In some implementations, the optoelectronic device includes a plurality of optical channels separated by a baseline. Each optical channel can be operable to generate output signals of an object.

In some implementations, the optoelectronic device includes a textured-light active illumination.

In some implementations, the optoelectronic device includes a processor operable to generate distance data from output signals by determining disparity values between the output signals generated from a plurality of optical channel.

In some implementations, the optoelectronic device includes an active illumination that is modulated with a particular modulation frequency.

In another aspect, a method of generating output signals using an optoelectronic device that includes an event-driven photo array includes capturing a first intensity with an event-driven photo-array that includes a change-detection circuit, where the first intensity includes first light reflected from an object. The method further includes directing an active illumination onto the object, where the active illumination is generated from an illumination module over a particular illumination time. The method further includes capturing a second intensity with the event-driven photo-array within a particular illumination time, where the second intensity includes first light and second light, the second light being a portion of the active illumination reflected from the object. The method further includes generating an output signal with the event-driven photo-array, the output signal includes a photo-current corresponding to the difference between the second intensity and first intensity.

Some implementations include triggering a change-detection circuit by a threshold intensity change.

Some implementations include adjusting the power of an active illumination module such that an active illumination directed onto an object and reflected to an event-driven photo-array exceeds a threshold intensity change.

Some implementations include establishing a threshold intensity change to correspond to intensity changes that are greater than the first light reflected from an object.

Some implementations include directing the active illumination onto an object and modulating the active illumination with a particular modulation frequency.

Some implementations include correlating the output signal to distance data.

Some implementations include directing a first light onto an object. In such implementations, the first light can be generated from an illumination module over a particular illumination time.

Some implementations include directing a first light onto an object. In such implementations, the first light can be generated from an auxiliary illumination module.

Other aspects, features and advantages will be readily apparent from the following detailed description, the accompanying drawings, and the claims.

### BRIEF DESCRIPTION OF THE DRAWINGS

FIG. 1A depicts an example of an optoelectronic device.

FIG. 1B depicts another example of an optoelectronic device.

FIG. 2 is a flowchart illustrating a collection of operations for generating output signals.

FIG. 3 is another flowchart illustrating a collection of operations for generating output signals.

FIG. 4 is still another flowchart illustrating a collection of operations for generating output signals.

### DESCRIPTION

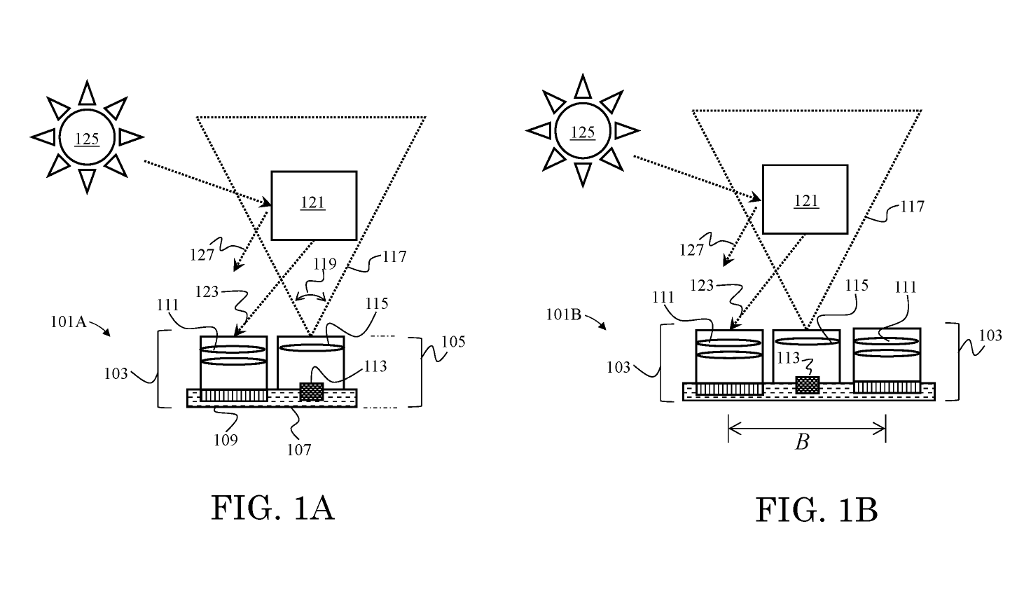

FIG. 1A depicts an example of an optoelectronic device 101A. The optoelectronic device 101A includes an optical channel 103 and an illumination module 105 mounted to a substrate 107 such as a printed circuit board. The optical channel 103 includes an event-driven photo-array 109 such as described in U.S. patent application Ser. No. 14/366,128, the contents of which are incorporated herein by reference in their entirety. The event-driven photo-array includes a change-detection circuit. The change-detection circuit can be triggered, for example, by a threshold intensity change in some instances. The event-driven photo-array can be mounted electrically to the substrate 107. In some instances, the optical channel 103 further includes an optical element 111 or multiple optical elements 111 such as diffractive lenses, refractive lenses, microlens arrays, and spectral filters. The illumination modules 105 includes a light-emitting component 113 such as a light-emitting diode, a laser diode, or an array of light-emitting diodes or laser diodes. In some instances, the optical channel 105 further includes an optical element 115 or multiple optical elements 115 such as diffractive lenses, refractive lenses, microlens arrays, and/or spectral filters. The illumination module 105 is operable to generate an active illumination 117 of a particular wavelength or range of wavelengths (e.g., 850 nm or 940 nm) over a field-of-illumination 119. The active illumination 117 can be directed onto an object 121 such as a human in a scene or another object. A portion of the active illumination 117 is reflected from the object 121 and can be incident on the optical channel 103 where it is focused onto the event-driven photo-array 109 (i.e., second light 123). In addition, another light source 125 such as the ambient light in out-of-doors scenes also can generate light that is reflected from the object 121 and onto the optical channel 103 where it is focused onto the event-driven photo-array 109 (i.e., first light 127). The ambient light that is reflected 127 can include light of the same particular wavelength or range of wavelengths as the active illumination 117.

FIG. 1B depicts another example of an optoelectronic device 101B. The optoelectronic device 101B includes multiple optical channels 103 and corresponding components as described above. In some implementations, optoelectronic device 101B can be operable to collect distance data of the object 121 such as stereo images of the object 121. In some implementations, optoelectronic device 101B can be implemented as a computational camera, i.e., it may be operable to generate high-resolution images of the object 121 from multiple lower-resolution images of the object 121 collected via each of the optical channels 103. The high-resolution images may be combined with distance data in some instances.

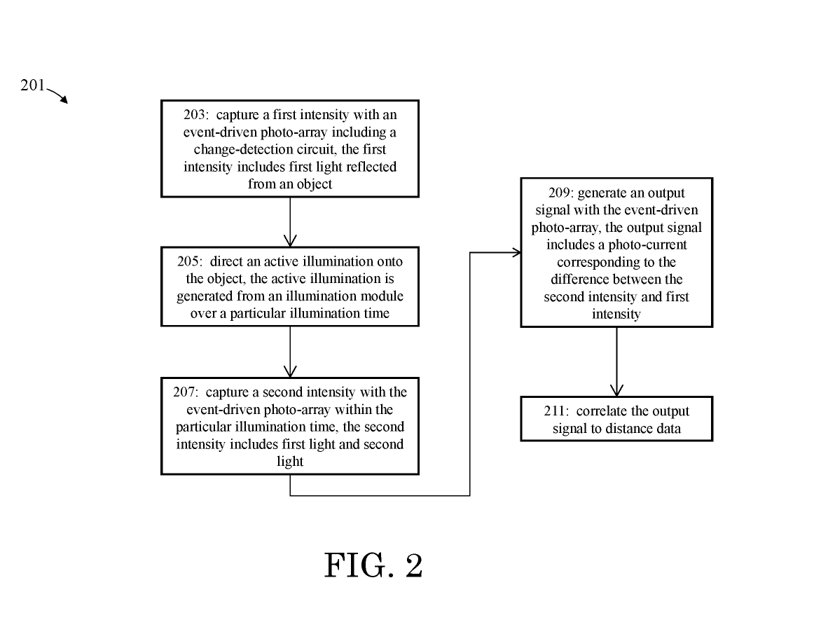

FIG. 2 is a flowchart illustrating a collection of example operations 201 for generating output signals. At 203, a first intensity is captured with an event-driven photo-array 109. In some implementations, the event-driven photo-array 109 includes a change-detection circuit. The first intensity includes first light 127 reflected from an object 121. The first light 127 can be generated by an ambient light source, such as the sun, for example. In some instances, first light 127 may be generated by an ambient light source directly, i.e., first light 127 need not reflect from the object 121.

At 205, an active illumination 117 is directed onto the object 121, the active illumination 117 is generated from an illumination module 105 over a particular illumination time. As described in subsequent implementations, the active illumination can be modulated with a particular frequency. In some implementations, the active illumination 117 may be structured-light (as implemented in structure-light techniques) or may produce the appearance of texture (as implemented in active stereo techniques).

At 207, a second intensity is captured with the event-driven photo-array 109 within the particular illumination time. The second intensity includes first light 127 and second light 123, wherein second light 123 includes the portion of active illumination reflected from the object 121. At 209, an output signal is generated with the event-driven photo-array 109. The output signal includes a photo-current corresponding to the difference between the second intensity and first intensity. Since, in some instances, the first intensity is associated with background light and the second intensity is associated with both background light and the portion of the active illumination 117 reflected from the object 121, their difference represents that portion of the active illumination 117 reflected from the object 121 (i.e., second light 123). Consequently, the output signal can be reliably used to generate distance data as described below.

At 211, the output signal is correlated to distance data by any of a number of techniques. For example, in some implementations, the output signal may be correlated to distance data by associating the output signal to proximity as implemented in typical proximity sensors. In some implementations, the output signal may be correlated to distance data by capturing stereo images of the object 121. In some implementations, the output signal may be correlated to distance data by structured-light techniques. Some of these implementations are discussed further, below.

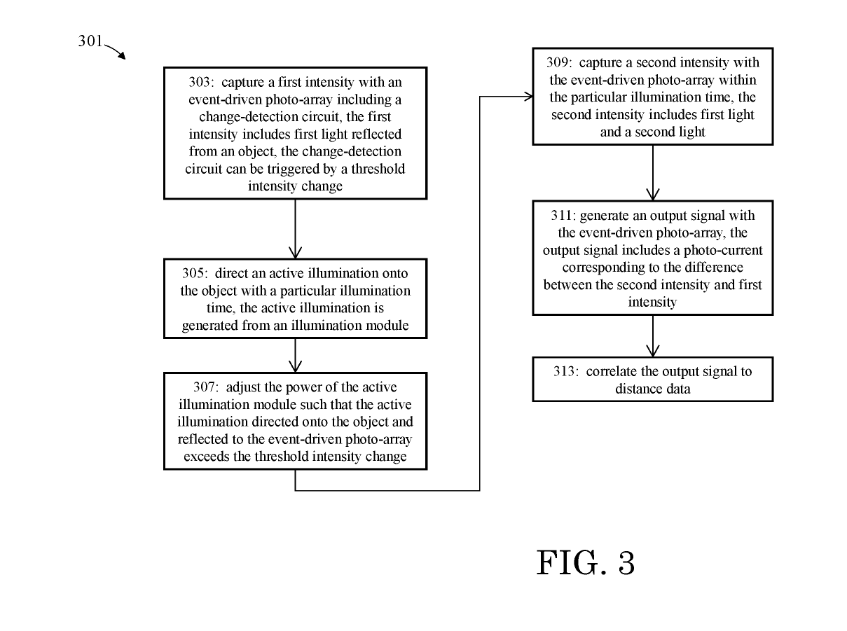

FIG. 3 is still another flowchart illustrating a collection of example operations 301 for generating output signals. At 303, a first intensity is captured with an event-driven photo-array 109. In some implementations, the event-driven photo-array 109 includes a change-detection circuit. The first intensity includes first light 127 reflected from an object 121. In some implementations, the change-detection circuit is triggered by a threshold intensity change. At 305, an active illumination 117 is directed onto the object 121. The active illumination 117 is generated from an illumination module 105 over a particular illumination time. At 307, the power of the active illumination module 105 is adjusted such that the active illumination 117 directed onto the object and reflected to the event-driven photo-array 109, i.e., the second light 123, exceeds the threshold intensity change.

At 309, a second intensity is captured with the event-driven photo-array 109 within the particular illumination time. The second intensity includes first light 127 (e.g., background light) and the second light 123 (the active illumination reflected 123 from the object 121). At 413, an output signal is generated with the event-driven photo-array 109. The output signal includes a photo-current corresponding to the difference between the second intensity and first intensity. At 415, the output signal is correlated to distance data as described above.

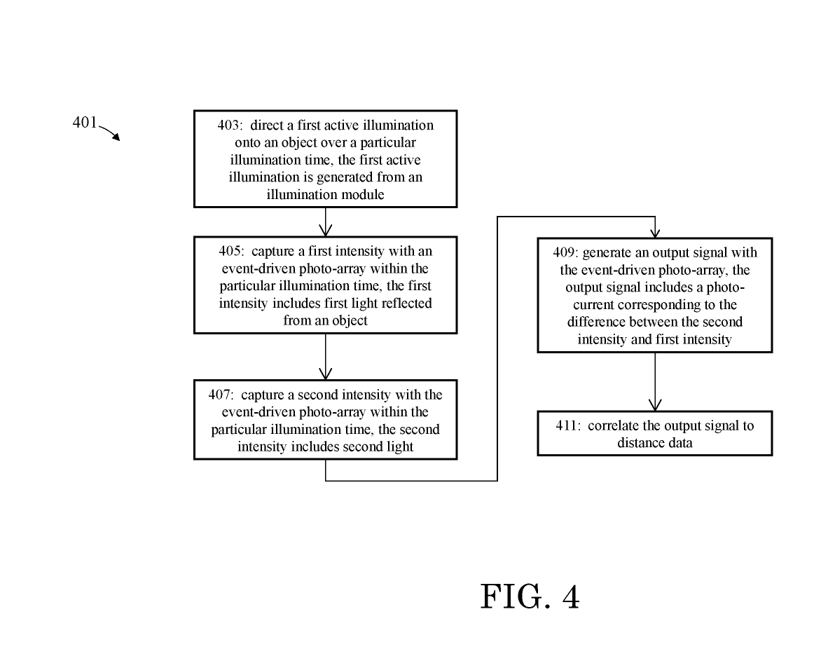

FIG. 4 is yet another flowchart illustrating a collection of example operations 401 for generating output signals. In some implementations, the first light 127 may be due to the active illumination 117. For example, first light 127 may be generated by the illumination module 105. In such instances, the object 121 need not be stationary. Accordingly, the first light 127 can be directed to the optical channel before the active illumination 117 is incident on the object 121. At 403, a first active illumination 117 is directed onto an object 121. The first active illumination 117 is generated from an illumination module 105 over a particular illumination time. At 405, a first intensity is captured with an event-driven photo-array 109. The first intensity includes first light 127 reflected from an object 121. In another step 407, a second intensity is captured with the event-driven photo-array 109 within the particular illumination time. The second intensity includes second light 123 reflected from the object 121, and first light 127. At 409, an output signal is generated with the event-driven photo-array 109. The output signal includes a photo-current corresponding to the difference between the second intensity and first intensity. At 411, the output signal is correlated to distance data as described above.

The aforementioned examples and implementations describe a series of operations for executing methods for operating an optoelectronic device that includes an event-driven photo-array. Various operations are described sequentially, though the operations need not occur in the sequence in which they are described in this disclosure. Moreover, operations may be carried out simultaneously or nearly simultaneously. Further, the example operations described above can be repeated in some instances. Moreover, other modifications may be made to the foregoing implementations, including the optoelectronic devices, and features described above in different implementations may be combined in the same implementations. Other implementations are within the scope of the claims.

What is claimed, is:

1. An optoelectronic device comprising:
an event-driven photo-array including a change-detection circuit, the change-detection circuit being triggered by a threshold intensity change;
the change-detection circuit being operable to generate output signals;
a processor in communication with the event-driven photo-array; and
an illumination module operable to direct an active illumination onto an object over a particular illumination time.

2. The optoelectronic device of claim 1, the illumination module being further operable to adjust the power of the active illumination such that the active illumination directed onto the object and reflected to the event-driven photo-array exceeds the threshold intensity change.

3. The optoelectronic device of claim 1, the active illumination being a structured-light illumination.

4. The optoelectronic device of claim 3, wherein the processor is operable to generate distance data from the output signals and the structured-light illumination.

5. The optoelectronic device of claim 1, further comprising an optical channel, the optical channel including an optical element assembly aligned to the event-driven photo-array.

6. The optoelectronic device of claim 5, further comprising a plurality of optical channels separated by a baseline, each optical channel being operable to generate output signals of the object.

7. The optoelectronic device of claim 6, the active illumination being a textured-light illumination.

8. The optoelectronic device of claim 7, wherein the processor is operable to generate distance data from the output signals by determining disparity values between the output signals generated from each optical channel.

9. The optoelectronic device of claim 1, the active illumination being modulated with a particular modulation frequency.

10. A method of generating output signals, the method comprising the steps of:
capturing a first intensity with an event-driven photo-array including a change-detection circuit, the first intensity including first light reflected from an object;
directing an active illumination onto the object, the active illumination being generated from an illumination module over a particular illumination time;
capturing a second intensity with the event-driven photo-array within the particular illumination time, the second intensity including first light and second light, the second light being generated from the illumination module and reflected from the object; and
generating an output signal with the event-driven photo-array, the output signal including photo-current corresponding to the difference between the second intensity and the first intensity.

11. The method of claim 10 further including the change-detection circuit being triggered by a threshold intensity change.

12. The method of claim 11 further including adjusting the power of the active illumination module such that the second intensity exceeds the threshold intensity change.

13. The method of claim 10 further including establishing the threshold intensity change to correspond to intensity changes that are greater than the first light reflected from the object.

14. The method of claim 10, wherein directing the active illumination onto the object includes modulating the active illumination with a particular modulation frequency.

15. The method of claim 10, further including correlating the output signal to distance data.

16. The method of claim 10, further including directing the first light onto the object, the first light being generated from the illumination module.

17. The method of claim 10 further including directing the first light onto the object, the first light being generated from an auxiliary illumination module.
